(19) United States
(12) Patent Application Publication
(10) Pub. No.: US 2007/0154048 A1
(43) Pub. Date: Jul. 5, 2007

(54) Protective case for electro product with apparatus to receive earphone

(75) Inventor: Shu-Ming Chang, Taichung City (TW)

Correspondence Address: BIRCH STEWART KOLASCH & BIRCH, PO BOX 747, FALLS CHURCH, VA, 22040-0747, US

(73) Assignee: LEE BOU LABEL ENTERPRISE CO., LTD.

(21) Appl. No.: 11/320,814

(22) Filed: Dec. 30, 2005

(51) Int. Cl. H04R 25/00

(52) U.S. Cl. 381/371

(57) ABSTRACT

A protective case includes a chamber to receive an electro device therein. The electro device, such as MP3 player, has an earphone with a wire, a plug and two speakers. The protective case is provided with an earphone fixing device on a back thereof. The earphone fixing device includes a post and a plate on a top of the post. the post has a circumference to wind the wire of the earphone thereon, and the plate has a plug recess and two earphone recesses on a top thereof to receive the plug and the speakers therein.

### BACKGROUND OF THE INVENTION

1. Field of the Invention

The present invention relates generally to an accessory of the electro product, and more particularly to a protect case for electro product, which can receive the ear phone of the electro product.

2. Description of the Related Art

Portable music players, such as MP3 players, are the most popular electro product in the present market. It has small size for user to carry it. User may hang it on the neck, put it in the pocket, fasten it on the arm, and so on, and listen to music by the earphone. The player may be put in a soft case. This case provides a kind of protect of the MP3 player.

The earphone is the troublesome thing when user carries the MP3 player. Conventional earphones have a wire about one meter long, and there is no place on the MP3 player or on the soft case to receive the earphone. It bothers user to receive the earphone when user doesn't listen to music and still carries the MP3 player.

### SUMMARY OF THE INVENTION

The primary objective of the present invention is to provide a protect case for electro product, which can receive the ear phone of the electro product.

According to the objective of the present invention, a protective case for an electro device, which the electro device has an earphone with a wire and at least a speaker, comprising a chamber to receive the electro device therein and an earphone fixing device on a side thereof, wherein the earphone fixing device includes a post with a circumference to wind the wire of the earphone thereon.

### BRIEF DESCRIPTION OF THE DRAWINGS

FIG. 1 is a perspective view of a preferred embodiment of the present invention;

FIG. 2 is a back view of the preferred embodiment of the present invention;

FIG. 3 is a lateral view of the preferred embodiment of the present invention; and

FIG. 4 is a sectional view along 4-4 line of FIG. 2.

### DETAILED DESCRIPTION OF THE INVENTION

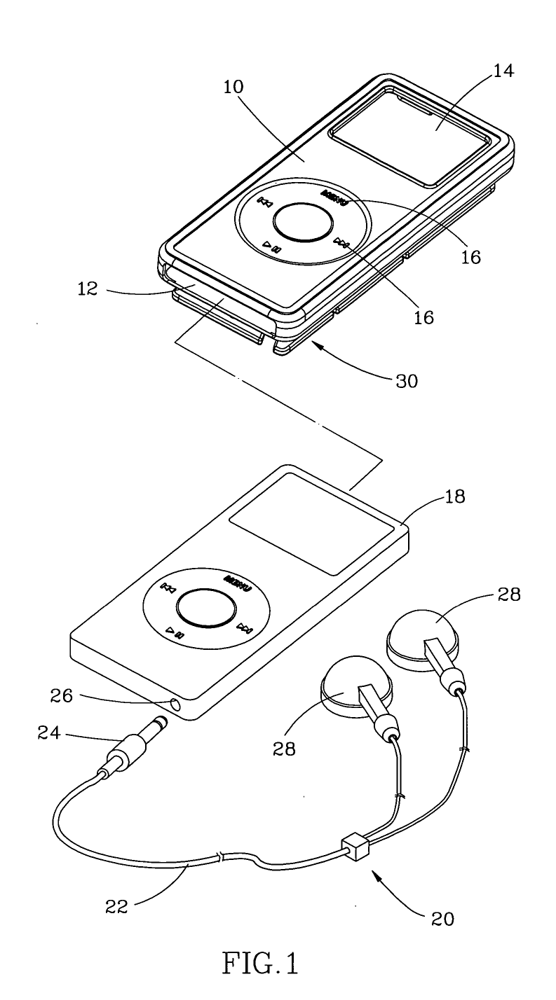

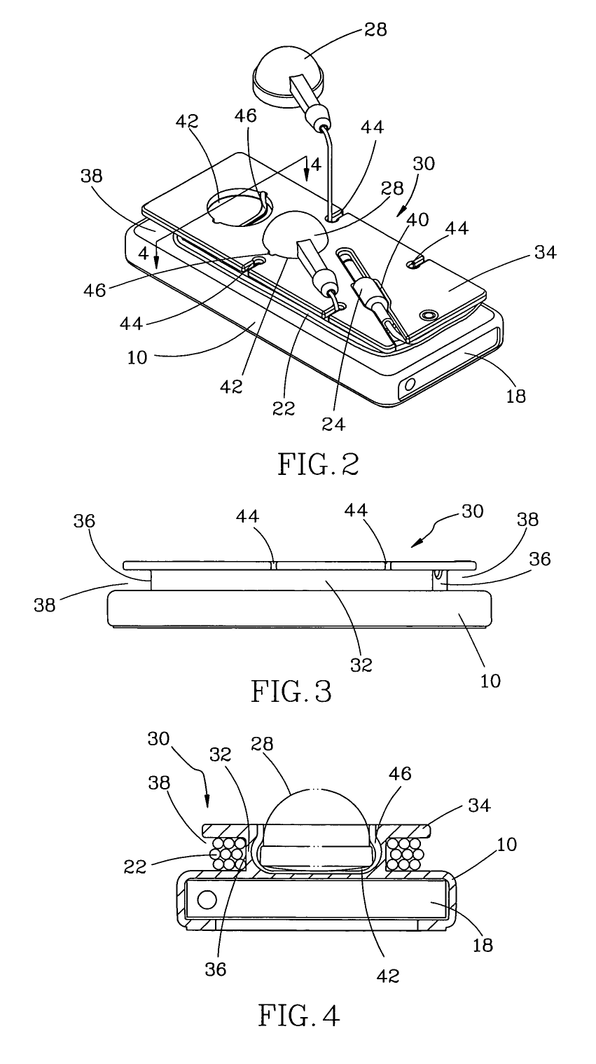

As shown in FIG. 1 to FIG. 4, a protective case 1 of the present invention, which is made of a soft material, such as rubber, silicon rubber or the other materials, has a chamber 12 to receive an electro product 18, such as music player, therein, a window 14 at a front side and several operating portions 16. The electro product 18 has an earphone 20, which has a wire 22 with a plug 24 and two speakers 28 at opposite ends thereof. The plug 24 can be inserted into a socket 26 of the music player 18 to transmit signals.

The protective case 10 is provided with an earphone fixing device 30 on a back thereof. The device 30 includes a post 32 projected from the back of the case 10 and a plate 34 on a top of the post 32. The post 32 has a circumference 36. The plate 34 has an area greater than that of the post 32 so that there is an annular space 38 between the plate 34 and the back of the case 10. The plate 34 is provided with a plug recess 40 and two speaker recesses 42 on a top thereof and has four apertures 44 at two edges thereof. The plug 24 of the earphone 20 can be squeezed into the plug recess 40 and the speakers 28 can be squeezed into the speaker recesses 42 to store the plug 24 and the speakers 28 of the earphone 20. The plate 34 is provided with an air channel 46 on sidewalls of the speaker recesses 42 respectively to flow gas in and out when the speakers 28 is squeezed in or pulled out of the speaker recesses 42 that can prevent the speakers 28 from damage by pressure.

In use, user may put the electro device 18 in the protective case 10 and listen to music by the earphone 20. When not use, user may squeeze the plug 24 into the plug recess 40, and wind the wire 22 around the circumference 36 of the post 32 to store the wire 22 in the space 38, and then insert the wire in the apertures 44 and squeeze the speakers 28 into the speaker recesses 42. Therefore, the earphone 20 is received in the earphone fixing device 30 of the protective case 10 of the present invention.

In practice, the plug 24 of the earphone 20 may keep in being inserted in the electro device 18. In this condition, the wire 22 can be wound on the circumference 36 of the post 32 and the speakers 28 are squeezed in the speaker recesses 42 as well.

What is claimed is:

1. A protective case for an electro device, which the electro device has an earphone with a wire and at least a speaker, comprising a chamber to receive the electro device therein and an earphone fixing device on a side thereof, wherein the earphone fixing device includes a post with a circumference to wind the wire of the earphone thereon.

2. The protective case as defined in claim 1, wherein the earphone fixing device further includes an earphone recess with a shape complementary to the speaker of the earphone.

3. The protective case as defined in claim 2, further comprising an air channel on a sidewall of the earphone recess.

4. The protective case as defined in claim 1, wherein the earphone has a plug and the earphone fixing device has a plug recess with a shape complementary to the plug.

5. The protective case as defined in claim 1, wherein the earphone fixing device has an aperture on an edge thereof.

6. The protective case as defined in claim 1, wherein the earphone fixing device further includes a plate on a top of the post with an area greater than that of the post, under which an annular space is formed to receive the wire therein.

7. The protective case as defined in claim 6, wherein the earphone fixing device further includes an earphone recess on a top of the plate with a shape complementary to the speaker of the earphone.

8. The protective case as defined in claim 7, further comprising an air channel on a sidewall of the earphone recess.

9. The protective case as defined in claim 6, wherein the earphone has a plug and the earphone fixing device has a plug recess on a top of the plate with a shape complementary to the plug.

10. The protective case as defined in claim 6, wherein the earphone fixing device has an aperture on an edge on a top of the plate.
